(19) United States
(12) Patent Application Publication
(10) Pub. No.: US 2024/0325922 A1
(43) Pub. Date: Oct. 3, 2024

(54) PERSONALIZING A VIDEO GAME PRIZE

(71) Applicant: ARTIE, INC., West Hollywood, CA (US)

(72) Inventor: Armando McIntyre-Kirwin, Los Angeles, CA (US)

(21) Appl. No.: 18/194,660

(22) Filed: Apr. 3, 2023

(51) Int. Cl. A63F 13/65; A63F 13/216

(52) U.S. Cl. CPC A63F 13/65; A63F 13/216

(57) ABSTRACT

The system obtains data associated with the user by obtaining the indication of the portal through which the user reached the video game and device information associated with the user device. The system obtains multiple prize categories including an item and an activity. Based on the data associated with the user and the multiple prize categories, the system personalizes the video game by creating the video game prize associated with the user in a prize category among the multiple prize categories.

### BACKGROUND

An app store is a digital distribution service operated by various platforms, such as Google and Apple, that allows users to browse and download software applications such as video games. To download the game, the user needs to enter the app store and find, download, and install the game. The whole process involves several steps. The installation of the game can take several minutes to complete. Once the game is downloaded, users can play the game, however, the app store acts as a middleman constraining and, in some cases, modifying the interaction between the user and the video game provider.

### BRIEF DESCRIPTION OF THE DRAWINGS

Detailed descriptions of implementations of the present invention will be described and explained through the use of the accompanying drawings.

FIG. 1 shows a traditional system for playing a game on a mobile device.

FIG. 2 shows a traditional system for playing a game from an app store.

FIG. 3 shows a system enabling the user device to directly interact with a server providing the game.

FIG. 4 shows how a link to the game can be presented to the user.

FIG. 5 shows a frame from the game.

FIG. 6 is a flowchart of a method to enable a user to play a video game via a single-click selection of a link presented in a social media platform.

FIG. 7 shows a system to personalize a video game based on various user and user device attributes.

FIG. 8 is a flowchart of a method to personalize a video game.

FIG. 9 shows a system to personalize a video game prize.

FIG. 10 is a flowchart of a method to personalize the video game prize.

FIG. 11 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and a method to enable a user to play a video game via a single-click selection of a link presented in a social media platform. The video game can be a multiplayer video game and can enable user A from social media platform A and user B from social media platform B to play the video game together. The system creates a posting A on the social media platform A by a social media identity A associated with the multiplayer video game, where the posting A includes a link A to the multiplayer video game. The system also creates a posting B on the social media platform B by a social media identity B associated with the multiplayer video game, where the posting B includes the link A to the multiplayer video game.

Postings A and B can be made by users and include: a tweet on Twitter; a post on a user's Facebook “wall”; posts in messages such as the “direct message” section of twitter, Instagram, or TikTok; posts in the description of videos such as the “Description” section of a video posted on YouTube; or advertisements seen by users such as the advertisements that users see while watching Instagram stories or browsing their TikTok “feed.”

The system receives a single-click selection of the link A and a single-click selection of the link B, where the single-click selection of the link A is received through the social media platform A and the single-click selection of the link B is received through the social media platform B. Upon receiving the single-click selection of the link A, the system launches a multiplayer video game in an embedded browser A running within the social media platform A, where the user A making the single-click selection of the link A remains within the social media platform A while interacting with the embedded browser A. Similarly, upon receiving the single-click selection of the link B, the system can launch a multiplayer video game in an embedded browser B running within the social media platform B, where a user B making the single-click selection of the link B remains within the social media platform B while interacting with the embedded browser B. User B can also be an artificial intelligence (AI) in lieu of a human player.

The system enables the user A and the user B to play the multiplayer video game together through the embedded browsers A and B without downloading an executable to a user A device associated with the user A and a user B device associated with the user B.

Further, disclosed here is a system and a method to personalize a video game. The system can receive a request to play the video game from a user device associated with a player, where the request includes an indication of a portal through which the player reached the video game. Upon receiving the request, the system can obtain data associated with the player in several ways. First, the system can obtain the indication of the portal through which the player reached the video game, where the portal includes an indication of a software platform from which the user device made the request, or an indication of an advertising campaign through which the user device made the request. The advertising campaign can indicate age of the player, and age can indicate buying power of the player. Second, the system can obtain device information associated with the user device including a type of user device and a geographic location associated with the user device.

Based on the data associated with the player, the system can segment the player into a predetermined group among the multiple predetermined groups indicating a video game preference associated with the player. The preference can include the player's propensity to obtain high-value items associated with the video game, what game items the player tends to buy, or what games the player tends to engage in, what advertising campaign the player pays attention to.

Based on the predetermined group associated with the player, the system can personalize the video game. The system can determine whether the player has the propensity to obtain high-value items associated with the video game. Upon determining that the player has the propensity to obtain high-value items associated with the video game, the system can present a high-value item in the video game. Upon determining that the player does not have the propensity to obtain high-value items associated with the video game, the system can present a low-value item in the video game.

Finally, disclosed here is a system and a method to personalize a video game prize. The system can obtain data associated with the player, as described in this application. Based on the data associated with the player, the system can determine a geographic location associated with the player. The system can obtain multiple prize categories including an item and an activity. Based on the data associated with the player, the geographic location associated with the player, and the multiple prize categories, the system can personalize the video game by creating the video game prize associated with the player in an appropriate prize category.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Enabling a User to Play a Multiplayer Video Game via a Single-Click Selection of a Link Presented in a Social Media Platform

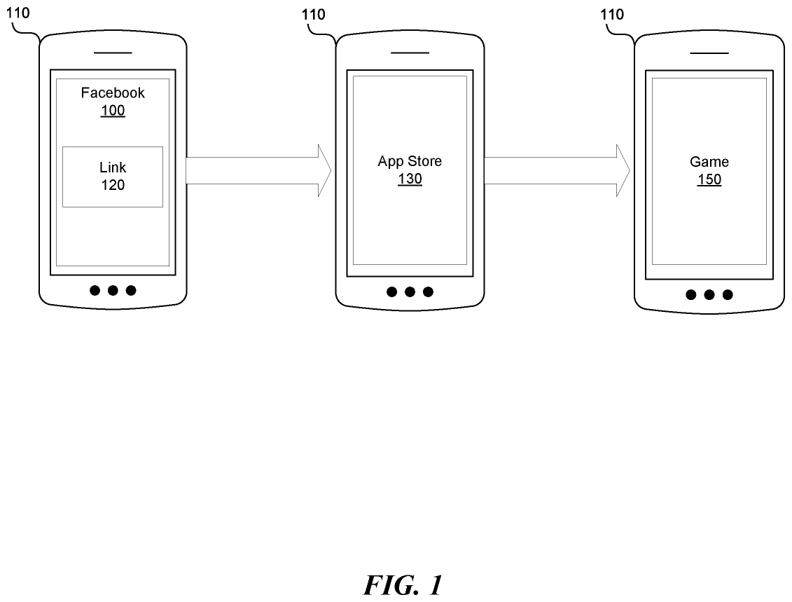

FIG. 1 shows a traditional system for playing a game on a mobile device. Traditionally, a user can visit a social media platform 100 on a user device 110, such as a mobile device, a smart watch, a tablet, a personal digital assistant, a desktop computer, etc. The social media platform 100 can present an advertisement or a link 120 to a game. If the user wishes to play the game, the user can select the link 120. Upon selecting the link 120, the user device 110 presents an app store 130, such as a Google or Apple app store, to the user. The app store 130 is a separate software application (“application”) from the social media platform 100, and interactions between the app store 130 and the user are not communicated with the social media platform 100.

Once the user device 110 presents the app store 130, the user needs to download the application for the video game (“game”) 150. Once the game 150 is downloaded on the user device 110, the user can play the game. This process involves a significant overhead for the user because the process involves three steps and a noticeable amount of time (approximately five minutes) to select the game, go to the app store, and install the game on the user device 110. By contrast, the disclosed technology requires a single-click selection of the link representing the game and instant playing of the game without the need to download the application for the game 150 to the user device 110, as described below.

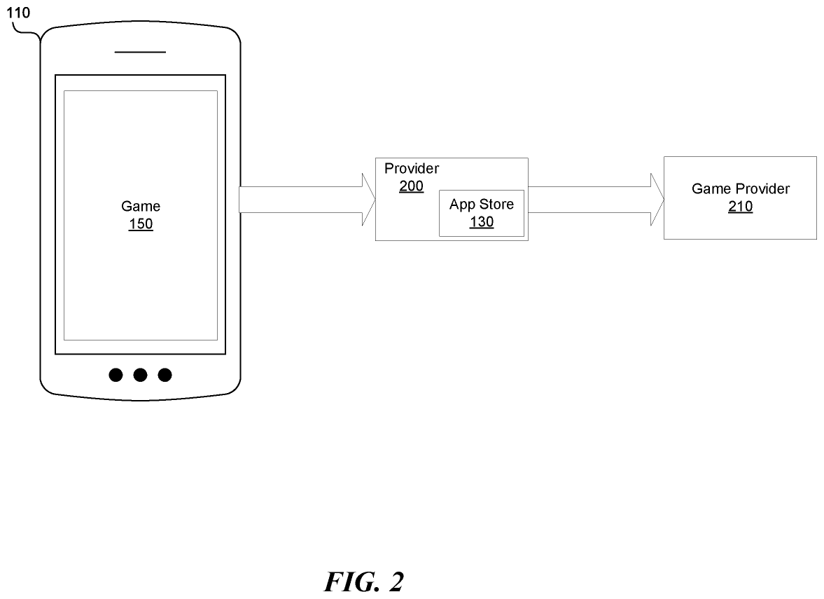

FIG. 2 shows a traditional system for playing a game from an app store. Once the user device 110 downloads the game 150 from the app store 130, the user executes at least part of the game 150 on the user device 110. The quality of the game in this scenario is at least partially limited by the technical capabilities of the user device 110. In addition, the user actions are first processed by the provider 200 of the app store 130. For example, if the app store 130 is provided by Google, the provider 200 is Google, or if the app store 130 is provided by Apple, the provider 200 of the app store 130 is Apple. The app store 130 gathers the user interactions with the game 150, processes them, and sends them to the game provider 210.

The app store 130 in the processing step can limit which interactions reach the game provider 210, and even for the interactions that do reach the game provider 210, the app store 130 can modify the interactions. For example, the app store 130 can modify payments made in the game 150. Specifically, if the user purchases an item in the game 150, the app store 130 can take 30% off the price of the item and send 70% of the funds to the game provider 210. In addition, the app store 130 can prevent the game provider 210 from receiving certain user data, such as the time of day when the game is played, the amount of time that the user plays the game, user demographics, etc.

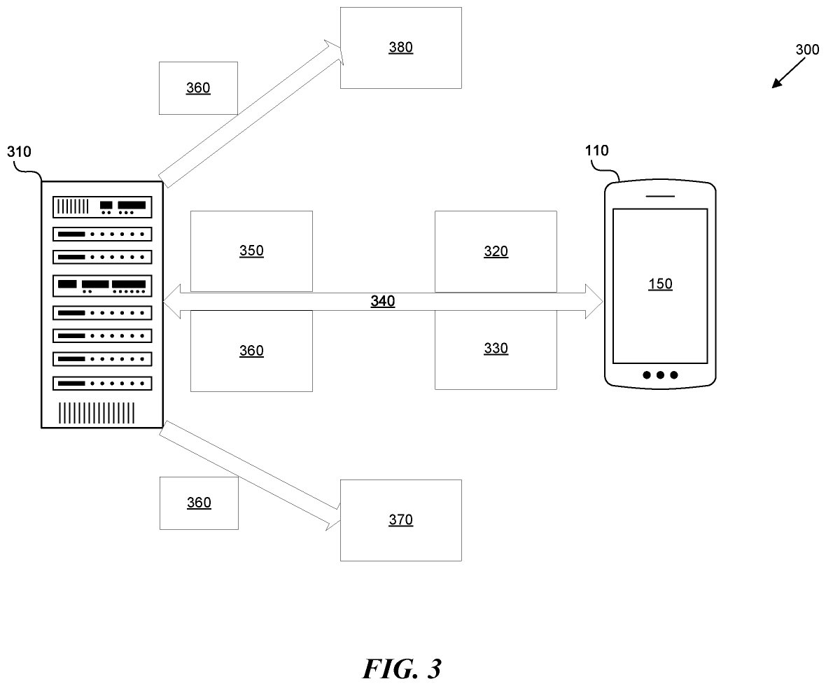

FIG. 3 shows a system 300 enabling the user device 110 to directly interact with a server 310 providing the game. In the system 300, the user device 110 can interact directly with the server 310 without the interference of the provider 200 in FIG. 2. The user device 110 sends all the user interactions 320 to the server 310. Consequently, the server 310 receives all the payments that the user makes in the game and gathers user data 330 such as an amount of time the user plays the game, user demographics, time of day when the user plays the game, etc.

In the system 300, the game 150 mostly executes on the server 310, which has higher computational resources than the user device 110. Consequently, the appearance of the game and the functions of the game can be more sophisticated than in the traditional system where the game was at least partially executing on the user device 110. In the system 300, the limiting factor on the quality of the graphics delivered to the user device 110 can be the network bandwidth 340 and/or the computational resources of the user device 110.

To increase the quality of the graphics delivered to the user device 110, the server can determine the assets 350 that need to be delivered to the user device 110, such as static images, animated images, animations, software, etc. The server 310 can determine the chronological order of the assets 350. In other words, the server can determine at what time the user device 110 will need a particular asset among the assets 350 and can deliver the assets 350 in the chronological order.

Additionally, the server 310 can adjust the quality of the assets 350, such as images and animations delivered to the user device 110, based on the network bandwidth 340 and/or the computational resources of the user device 110. For example, if the network bandwidth 340 is low, the server can provide lower-resolution static and animated images and/or animations to the user device 110.

Because the server 310 is directly interacting with the user device 110, without constraints imposed by the provider 200 in FIG. 2, the server 310 and the user device 110 can communicate new data structures 360 with each other. The new data structure 360 can be a non-fungible token (NFT). The NFT 360 can represent an asset such as a character, an object, a reward, or a purchase that the user made in the game 150. The NFT 360 can be dynamic and can change. For example, the NFT 360 can represent the user's character, and as the user progresses through the game 150, the character can gain additional armor, skills, or the character can change the appearance, etc. The NFT 360 can update based on the character changes in the game. In addition, the server 310 can distribute the NFT 360 to the various platforms 370, 380 that can interact with the NFT. Consequently, the platforms 370, 380 can receive the updates to the NFT 360.

For example, the other platforms 370, 380 can include social media platforms, gaming platforms, NFT marketplaces, etc. If the character adds an ax to his armor, the other platforms 370, 380 can update the appearance of the character to include the ax.

In addition, the system 300 can optimize the assets 350 delivered to the user device 110 based on the type of the user device 110. When the user device 110 is a mobile device, which inherently has less computing power than a personal computer, the system 300 can adjust a multitude of factors that increase or decrease performance of the code delivered to the user device 110, including the data size of digital assets, resolution of graphics, fidelity of digital assets such as audio files or image files, number of polygons, framerates, and more.

The system 300 can provide a distributed login/user account management system that sits behind each instance of multiple games 150. For example, the game 150 can track the user's login, state (e.g., user's progress across multiple sessions of the same game and across multiple games), and payment processing features. Effectively, any user interacting with any game 150 in the network of games offered by the system 300 essentially “joins” the platform and thus has a unified user account across any of the existing games 150 and games that other people make on the platform in the future.

The system 300 improves the concept of a traditional in-game leaderboard by making the leaderboard accumulate players from across the social media platforms into one “meta-leaderboard” that exists across all social media platforms.

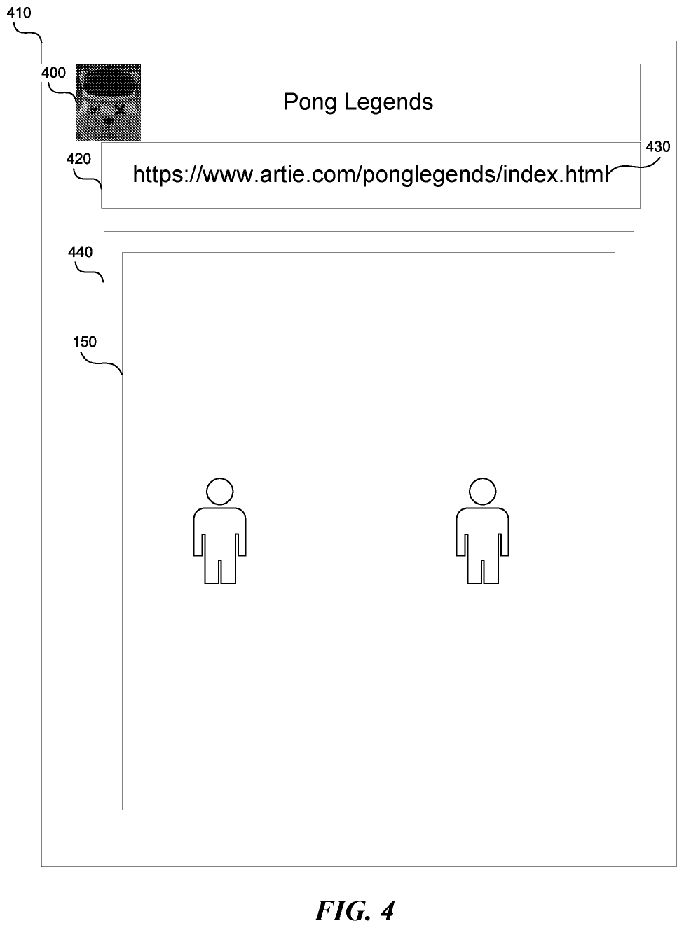

FIG. 4 shows how a link to the game can be presented to the user. The game 150 can have a social media identity 400 that can post updates on various social media platforms 410 such as TikTok, Facebook, Twitter, YouTube, Instagram, etc. The updates can include news about the game 150, release updates, tips on how to play the game, details about the appearance of a special feature in the game, etc. The social media identity 400 representing the game 150 can have followers. In addition, the social media identity 400 can create posts 420 including a link 430 to the game 150. The social media identity 400 can determine which posts 420 are popular, e.g., based on the number of views and/or likes, and can try to generate similar content in the future. The social media identity 400 can interact with other users of the social media platform through posting, commenting, following at least a portion of the other users, receiving comments from at least a portion of the other users, and garnering followers on the social media platform as a human user can. For example, the social media identity's 400 posts 420 can be reshared with others, and the social media identity 400 can reshare other users' posts.

The user can follow the social media identity 400 on the social media platform 410. The user can select the link 430 to the game 150, and instead of being redirected to the app store 130 as in FIG. 1, the system can present an embedded browser 440 through which the user can play the game 150. In this scenario, the user can make a single-click selection of the link 430 and instantly start to play the game 150, as opposed to having to perform three steps, interact with three different applications, download an application, and wait several minutes for the installation.

The embedded browser 440 runs within the social media platform 410 and enables the user to stay within the social media platform 410. The user can easily indicate to the game to go back to the social media platform 410, such as with the swipe gesture. Once the user exits the game, the user is presented with the user interface of the social media platform 410.

The game 150 can be a multiplayer game. Different users from different social media platforms 410 can join the same game 150 and play with each other at the same time.

The server 310 in FIG. 3 can gather information about the user interactions with the game. For example, the server 310 can determine a time period, such as between 8 p.m. and 9 p.m., when the user interacts with the game 150, and the social media identity 400 can post the link 430 to be visible to the user during that time period. In addition, the server 310 can model not only individual behavior, but group behaviors as well.

The server 310 can separate the users into groups based on the social media platform 410 viewed by the users and can provide posts based on the social media platform. For example, the server 310 can determine that the Instagram users play the game 150 between noon and 1 p.m., while the TikTok users play the game 150 between 1 p.m. and 5 p.m. Consequently, the social media identity 400 can post the link 430 to Instagram between noon and 1 p.m. and post the link to TikTok between 1 p.m. and 5 p.m. Each link posted by the social media identity 400 can include a code identifying the social media platform 410 in which the user is viewing the post and selecting the link. The server 310 can receive the code and can group the users based on the code.

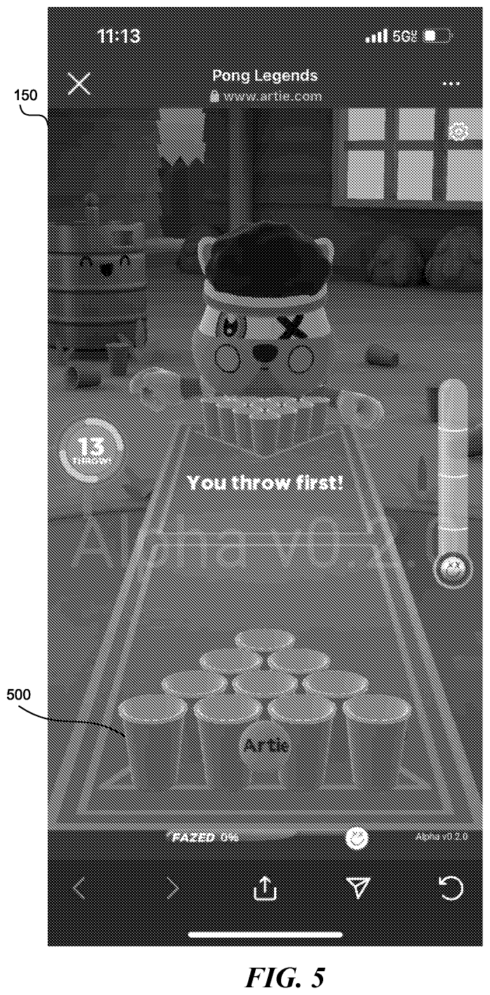

FIG. 5 shows a frame from the game 150. The game 150 enables users to play virtual beer pong with each other. The number of cups 500 determines the length of the game. As explained in this application, the server 310 can gather user data, such as how much time the user and/or a group of users spends in the game 150. If the server 310 in FIG. 3 determines that user A spends three minutes but user B spends 10 minutes playing the game, the server 310 can adjust the game to last the appropriate amount of time. For example, for user A, the system can present the game 150 with two opponents having four cups each, while for user B, the system can present the game 150 with two opponents having nine cups each.

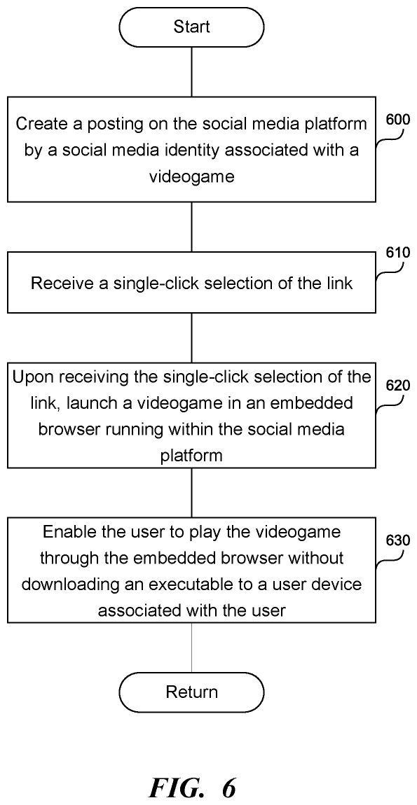

FIG. 6 is a flowchart of a method to enable a user to play a video game via a single-click selection of a link presented in a social media platform. In step 600, a hardware or software processor performing instructions described in this application can create a first posting on the first social media platform by a first social media identity associated with a multiplayer video game (“video game” or “game”), where the first posting includes a first link to the multiplayer video game. Additionally, the processor can create a second posting on the second social media platform by a second social media identity associated with the multiplayer video game, where the second posting includes a second link to the multiplayer video game.

In step 610, the processor can receive a single-click selection of the first link and a single-click selection of the second link, where the single-click selection of the first link is received through the first social media platform and the single-click selection of the second link is received through the second social media platform.

In step 620, upon receiving the single-click selection of the first link, the processor can launch a multiplayer video game in a first embedded browser running within the first social media platform, where a first user making the single-click selection of the first link remains within the first social media platform while interacting with the first embedded browser. Upon receiving the single-click selection of the second link, the processor can launch a multiplayer video game in a second embedded browser running within the second social media platform, where a second user making the single-click selection of the second link remains within the second social media platform while interacting with the second embedded browser.

In step 630, the processor can enable the first user and the second user to play the multiplayer video game together through the first and the second embedded browser without downloading an executable to a first user device associated with the first user and a second user device associated with the second user. The processor can receive an indication to exit from the multiplayer video game. Upon exiting from the multiplayer video game, the processor can present a user interface of the first social media platform to the first and the second user.

The processor can create an NFT representing an asset associated with the video game. The asset can include a prop, a character, a reward received in the video game or a purchased item, a character attribute such as a skill, etc. The processor can enable access to the NFT from the video game and a third-party software including the social media platform. The processor can receive an indication to modify at least a portion of the asset, and as a result can modify the asset. The processor can propagate the modification of the assets to the video game and the third-party software including the social media platform.

The processor can obtain data associated with the first user from an interaction between the first user and the first embedded browser, where the data includes an average time period that the first user engages with the multiplayer video game. The processor can adjust the video game to last within the average time period. For example, if the user plays the game for two to three minutes, the processor can reduce the number of cups in FIG. 5 so that the user game lasts two to three minutes. The processor can group users based on the platform, and the processor can adjust the game based on the platform, not just the user.

The processor can determine assets associated with the multiplayer video game to download to the first user device. The processor can determine a chronological order of assets needed by the first user device. The processor can provide the assets to the first user device based on the chronological order. For example, the processor can create a queue in chronological order of the assets that are needed next and provide assets to the device in the order in which they are needed.

The processor can obtain data associated with the first user from an interaction between the first user and the first embedded browser, where the data includes a time period, such as from 11 p.m. to midnight on weekdays and 10 p.m. to midnight on weekends, when the first user tends to be active on the first social media platform. During the time period, e.g., from 11 p.m. to midnight on weekdays and 10 p.m. to midnight on weekends, the processor can present the first posting.

The processor can determine network bandwidth between a server executing the multiplayer video game and the first user device or a computational capability associated with the first user device. The processor can adjust appearance associated with the game based on the network bandwidth or the computational capability.

The processor can obtain data associated with the first user from an interaction between the first user and the first embedded browser. Based on the data associated with the first user, the processor can adjust an attribute associated with the game.

To create the posting on the social media platform, the processor can obtain an advertisement. The processor can modify the advertisement to include a play button configured to launch the multiplayer video game in the embedded browser. The processor can create the posting including the modified advertisement.

### Personalizing a Video Game Based on Various User and User Device Attributes

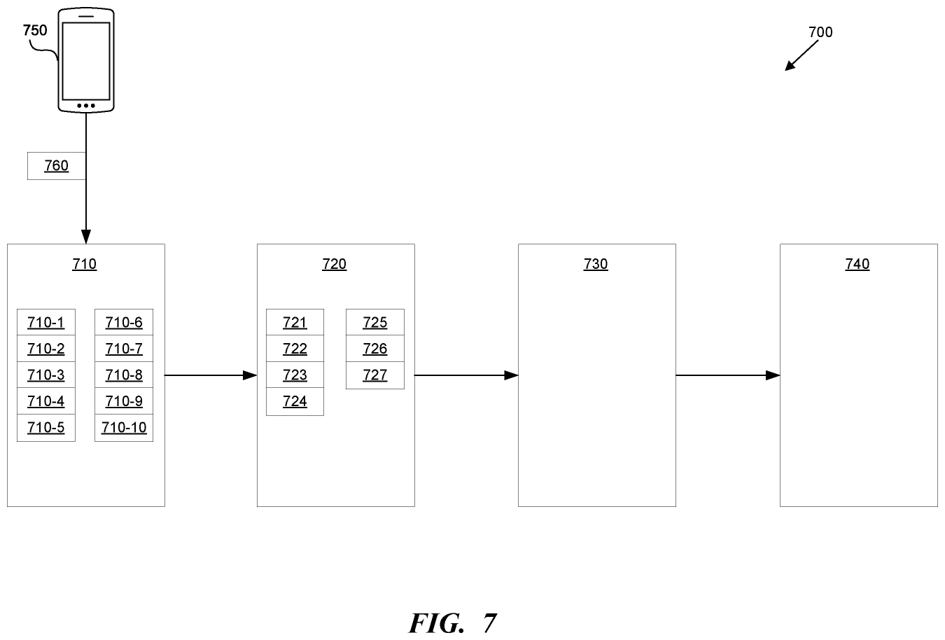

FIG. 7 shows a system to personalize a video game based on various user and user device attributes. The personalization system (“system”) 700 can include four stages or modules: the attribution module 710, the segmentation module 720, the personalization module 730, and the sharing module 740.

The attribution module 710 can gather information about user attributes and about a user device 750 attributes. To initiate the video game play, the user device 750 can send a request 760 including an indication of a portal through which the user (e.g., player) reached the video game. The portal can indicate a software platform, e.g., a social media platform, from which the user made the request 760 or an advertising campaign that the user selected prior to making the request 760. For example, the portal can indicate that the user came from Twitter, or Google, or by following an influencer who made a post containing a link to the video game. The attribution module can obtain information about the software platform 710-1 and/or the advertising campaign 710-2 to which the user responded.

In addition, the attribution module 710 can obtain information about a type 710-3 of the user device 750, such as Apple or Android, Internet protocol (IP) address 710-4 of the device, or operating system (OS) information 710-5. In the traditional system of mobile video game playing involving an app store, the system 700 does not get the information from the attribution module 710, in particular, the portal information. Consequently, video games downloaded from an app store cannot offer the degree of personalized experience described in this application. The attribution module 710 can obtain the information from the user device 750 and/or from the portal through which the user reached the system 700. For example, the portal can provide information about the portal to the attribution module 710.

The system can also get data based on user actions in the video game such as length of play 710-6, frequency of play 710-7, money spent in the game 710-8, games and type of games played 710-9, game activities 710-10, etc.

The segmentation module 720 can segment the user into a predetermined group among multiple groups. The multiple groups can include groups based on age 721, geographical location 722, the user's purchasing power 723, e.g., the user's propensity to buy high-value items, game items the user tends to purchase 724, game types the user plays 725, the advertising campaign to which the user responded 726, software platform from which the user selected the game 727, etc. The segmentation module 720 can segment users that are already part of the system 700 and have previously played the game, and users who are engaging with the video game for the first time.

The segmentation module 720 can determine to which group among the multiple groups 721-727 the user belongs based on the data 711-1 through 711-10 gathered by the attribution module 710. For example, the segmentation module 720 can determine the user's purchasing power 723 based on the device information and user information. For example, based on the device information such as IP address, the system can determine the geographic location of the user, thus indicating the user's purchasing power. In another example, device information such as OS information, device type, browser running on the device, etc., can indicate whether the device is an Apple device or an Android device. The system 700 can segment the Apple device user into a higher purchasing power group, and the Android device user into a lower purchasing power group.

The personalization module 730 can modify a landing page of the video game based on the software platform from which the user made the request 760. For example, the landing page can vary based on whether the user comes from TikTok or Instagram. Similarly, the personalization module 730 can present different leader boards or different prizes based on the software platform. For example, the system 700 can determine that TikTok players have lower purchasing power than Instagram players, and the system can tend to present inexpensive items to TikTok players.

The personalization module 730 can create a personalized activity within the video game. For example, the personalization module 730 can create a personalized modification such as a personalized giveaway, a personalized tournament, a personalized game event, a personalized prize, etc., based on the portal. In a more specific example, the personalization module 730 can limit the personalized modification to only the users that came from Twitter. Alternatively, the personalization module 730 can make the personalized modification specific to a particular advertisement campaign to which the user responded. The personalization module 730 can also enable users with different portals to participate in the same video game event, but for personalized prizes. For example, the system 300 can organize tournaments between users of different platforms such as Twitter users versus Instagram users.

The personalization module 730 can change pricing of items in the video game based on the geographic location associated with the user or the portal through which the users come. For example, if the personalization module 730 determines that Meta users spend a lot of money in the video game, the personalization module 730 can design a Meta welcome bundle of video game items for Meta users that the other users cannot see. In another example, the personalization module 730 can offer vanity items to users based on the portal through which the users reached the video game.

The personalization module 730 can adjust the color scheme based on the portal. For example, if the user reached the video game through Twitter, the personalization module 730 can use a blue color scheme. In another example, if the user came from Instagram, the personalization module 730 can offer Instagram filters to modify the video game characters or any of the items inside the video game.

The personalization module 730 can determine that the user reached the video game through a specific advertising campaign such as a campaign associated with a brand name like Gucci. Consequently, the personalization module 730 can modify the game to re-create virtual Gucci items in the game, or to create virtual items with the Gucci brand.

The sharing module 740 can generate data for the user to share on social media platforms. The sharing module 740 can modify the generated data based on the portal from which the user comes and/or based on the region. For example, if the user comes from TikTok or Discord, the sharing module 740 can generate a video to post, while if the user comes from Twitter, the post includes an image accompanied by text. The sharing module 740 can modify the color of the post based on the portal, such as using blue colors if the user came from Twitter. Additionally, the sharing module 740 can adjust the language of the post based on the geographical location of the user. If the user is in Japan, the generated post can be in Japanese, while if the user is in an English-speaking country, the generated post can be in English. By contrast, if the user is playing the game downloaded from an app store, the game does not have access to the platform information, and the game can just provide a generic share button regardless of what platform the user came from.

The personalization module 730 and/or the sharing module 740 can include an artificial intelligence (AI) to automatically hyper-personalize the game. For example, the AI can modify the user interface of the game and/or the shared post, to find the optimal colors, placement of buttons, etc. In another example, the AI can change the difficulty of the game to increase the amount of revenue the game generates or the number of times the link to the game is shared. In a third example, the AI can modify the graphics of the game, such that certain players see the more cartoon-like graphics while others see more realistic graphics.

The system 300 can track users' in-game activity, whether they bring other users to the game, and with what users they tend to play the games. Based on this information, the system 300 can create a social network of players, e.g., an online guild system. If the system 300 knows an attribute of the user within the social network but does not know attributes of other users within the social network, the system 300 can infer that the unknown attributes are similar to the node attribute. For example, the system can know the age of a first user and can infer that the ages of other users in the social network are +/−five years of the age of the first user. Based on the age, the system 300 can personalize the game as described in this application.

The portal can be a Progressive Web App (PWA). The PWA allows the user to “save” a webpage to the home screen on the user device. The PWA can have an icon on the user device, just like an app, but when the icon is selected, the user device does not run the app, and instead runs a very simple browser window identical to the embedded browser experience. The PWA can provide an experience similar to an embedded browser experience. The system 300, using the PWA, can track the attribution, segmentation, can customize the in-game experience, and can optimize the sharing experience for each player, as described in this application. The PWA can be “bookmarked.” “Bookmarking” a PWA to the user device home-screen enables the system 300 to use traditional user device notification system. Consequently, the system 300 can use the traditional user device notifications to notify users who have bookmarked a PWA containing the link to the game, to come play the game again, to look at the game updates, to share news about the game, etc.

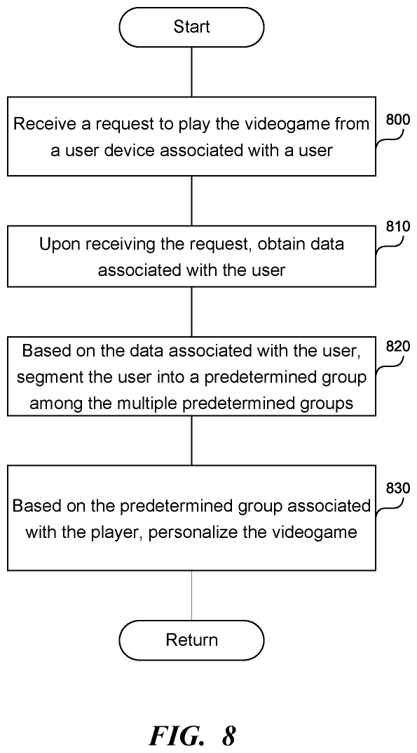

FIG. 8 is a flowchart of a method to personalize a video game. In step 800, a hardware or a software processor executing instructions described in this application can receive a request to play the video game from a user device associated with a user, e.g., a player. The request can include an indication of a portal through which the user reached the video game. The portal can be a software platform, such as a social media platform, from which the user device made the request or an advertising campaign to which the user responded. The advertising campaign can provide demographic information about the user, such as the user age.

In step 810, upon receiving the request, the processor can obtain data associated with the user in several ways. First, the processor can obtain the indication of the portal through which the user reached the video game. Second, the processor can obtain device information associated with the user device, including a type of user device, OS associated with the user device, device type, browser associated with the user device, IP address of the user device, geographic location associated with the user device, etc. Based on the data associated with the user, the processor can determine purchasing power of the user.

In step 820, based on the data associated with the user, the processor can segment the user into a predetermined group among the multiple predetermined groups. The multiple predetermined groups can indicate a video game preference associated with the user such as the user's purchasing power, e.g., user's propensity to obtain high-value items associated with the video game (such as items over $1-$10), the game items the user tends to buy, the games the user tends to engage in, the advertising campaign to which the user responded, etc.

In step 830, based on the predetermined group associated with the user, the processor can personalize the video game by adjusting an appearance of the video game based on the user's preferences. For example, the processor can determine whether the user has the propensity to obtain high-value items associated with the video game. Upon determining that the user has the propensity to obtain high-value items associated with the video game, the processor can present a high-value item in the video game. Upon determining that the user does not have the propensity to obtain high-value items associated with the video game, the processor can present a low-value item (such as an item under $1-$10) in the video game.

The processor can adjust shared content based on the portal from which the user joined the game. Based on the geographic location associated with the user device, the processor can determine a language associated with the user. The processor can generate content indicative of a video game experience associated with the user in the language associated with the user. The processor can enable the user to share the generated content on the software platform.

Based on the portal through which the user reached the video game, the processor can generate content indicative of a video game experience associated with the user. The processor can enable the user to share the generated content. For example, if the portal indicates an advertising campaign, the content can be generated in the style of the advertising campaign.

The processor can determine demographic information associated with the user, such as age, based on the advertising campaign. The processor can obtain the indication of the portal through which the user reached the video game by obtaining an indication of an advertising campaign through which the user device made the request, where the advertising campaign indicates an age associated with the user. The processor can segment the user into the predetermined group among the multiple predetermined groups based on the age associated with the user. The processor can determine whether the user has the propensity to obtain high-value items associated with the video game by: 1. determining whether the age associated with the user is above a predetermined threshold such as above 21-25 years old; and 2. upon determining that the age associated with the user is above the predetermined threshold, determining that the user has the propensity to obtain high-value items associated with the video game.

The processor can obtain the indication of the portal through which the user reached the video game by obtaining an indication of an advertising campaign through which the user device made the request, where the advertising campaign indicates a brand name, such as Dolce & Gabbana. The processor can personalize the video game by providing objects associated with the brand name in the video game.

The processor can determine the price of items in the game based on geographic location associated with the user. Upon receiving the request, the processor can obtain the data associated with the user by obtaining an IP address associated with the user device. Based on the IP address, the processor can determine a geographical location associated with the user device. The processor can personalize the video game by determining a price associated with an item based on the geographic location.

The processor can determine the price of items in the game based on the OS associated with the user device. Upon receiving the request, the processor can obtain the data associated with the user by obtaining an OS associated with the user device. The processor can personalize the video game by determining a price associated with an item based on the OS. For example, the processor can determine that iOS users spend more money than Android users and can price the items in the game accordingly.

Upon receiving the request, the processor can obtain the data associated with the user, including: an indication of the software platform from which the user device made the request, an indication of an advertising campaign through which the user device made the request, a browser type associated with the user device, an IP address associated with the user device, an OS associated with the user device, etc.

The processor can segment the user into a predetermined group among the multiple predetermined groups. For example, the processor can determine an age associated with the user based on the advertising campaign. The processor can determine a type associated with the user device based on the OS associated with the user device or the browser type associated with the user device. The processor can determine a geographic location associated with the user based on the IP address associated with the user device. The processor can determine the user's purchasing power based on the prior purchases in the game, the OS, the type of device, or the geographic location.

The processor can personalize the video game. The processor can determine a price associated with an item based on the user's purchasing power. The processor can determine a landing page based on the portal from which the user came. The processor can determine a leaderboard to present to the user based on the portal or geographic location of the user. The processor can determine the video game to present to the user based on the software platform or previous games with which the user has engaged. The processor can determine a prize to present to the user based on the geographic location, the portal from which the user came, or the type of user device.

### Personalizing a Video Game Prize

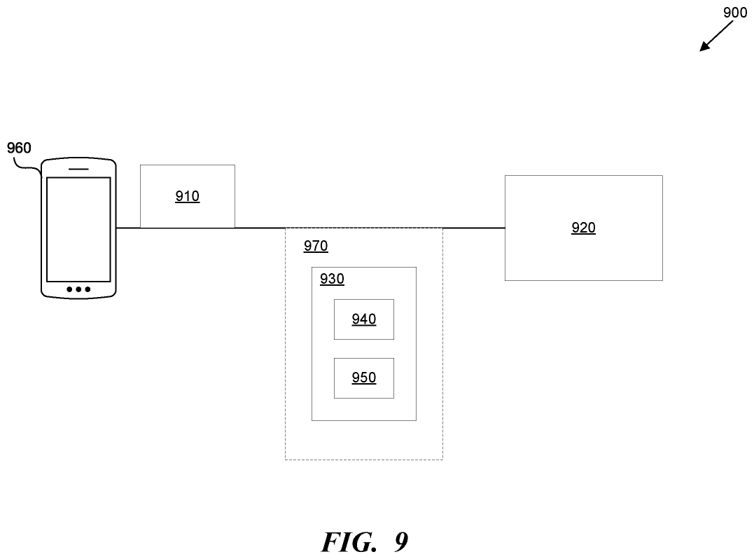

FIG. 9 shows a system to personalize a video game prize. The system 900 can gather data 910 about the player engaging with a video game 920. The system 900 can gather the data 910 about the player from the user device 960 and/or the portal through which the user reached the system 900, as described in this application. The player can engage with the video game via a user device 960. The data can include various data 710-1 through 710-10 in FIG. 7, 721-727 in FIG. 7, as described in this application. Based on the data 910, the system 900 can determine an appropriate prize 930 to deliver to the player. The prize 930 can be an item 940 and/or an activity 950.

The prize 930 can be encoded in an NFT 970. The player can exchange the NFT 970 on other platforms such as an NFT marketplace. Additionally, the player can redeem the NFT 970 for virtual reward or a physical object. Upon redeeming the NFT 970, the NFT 970 is destroyed.

If the prize 930 is the item 940, the prize can be a physical object, such as an electronic device, e.g., an iPhone, or an Android cell phone. The system 900 can determine the type of the electronic device based on the geographic location of the user, which a system can determine based on the IP address of the user device 960. For example, a majority of the users in the United States are iPhone users, while most of the users in Southeast Asia are Android users. If the system 900 determines that the user is in the United States, the system can offer an iPhone as the prize 930. The item 940 can be a virtual object such as a skill, a weapon, and/or a ticket to a game event, etc. The item 940 can include a bundle of items and a mix of physical objects and virtual objects.

If the prize 930 is the activity 950, the activity can include designing an aspect of the game 920. The aspect of the game can include designing a game tournament, game event, game character, and/or game background, etc. The game 920 can deploy the designed aspects inside the game. Other players of the game 920 can exchange their own items for the designed item, such as exchange video game currency or real currency for the designed item. The player who designed the item can get a percentage of the exchanged items, such as a percentage of the currency paid for the designed item.

To earn the reward, in one example, the system 900 can require the player to collect a certain quantity of virtual items, such as 20 necklaces, prior to the player being able to redeem the virtual items for a real-world item, such as a real necklace. In another example, to earn the reward, the system 900 generates a tournament where 99% of players have a chance of getting a toy object such as a toy car or a virtual car, but 1% of the people have a chance of getting the real car.

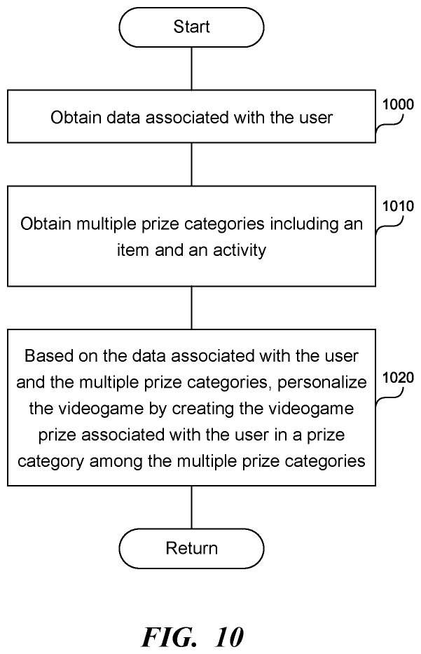

FIG. 10 is a flowchart of a method to personalize the video game prize. A hardware or software processor executing instructions described in this application can, in step 1000, obtain data associated with the user in several ways. First, the processor can obtain the indication of the portal through which the user reached the video game. The portal can include an indication of a software platform from which the user device made the request or an indication of an advertising campaign through which the user device made the request. Second, the processor can obtain device information associated with the user device, such as device type OS or IP address. The device information can indicate a geographic location associated with the user device. Based on the software platform from which the user device made the request, the processor can determine an appropriate prize category for the user. For example, TikTok users may be more interested in Android phones, while Instagram users may be more interested in Apple phones. Similarly, the advertising campaign, in addition to age, can indicate an advertised reward, such as a skill associated with a virtual character or a physical object. Based on the advertising campaign to which the user joined the game, the processor can determine the prize category for the user.

In step 1010, the processor can obtain multiple prize categories including an item and an activity. In step 1020, based on the data associated with the user and the multiple prize categories, the processor can personalize the video game by creating the video game prize associated with the user in a prize category among the multiple prize categories.

The processor can obtain the device information associated with the device, including an IP address associated with the device. Based on the IP address, the processor can determine a geographic location associated with the user. The processor can obtain an indication of a preferred device type associated with the geographic location. Based on the indication of the preferred device type associated with the geographic location, the processor can create the video game prize including the preferred device type.

To create the video game prize, the processor can generate an NFT indicating the prize, and the NFT is configured to be redeemed for a physical object. The NFT can also be exchanged at an NFT marketplace for other NFTs or other virtual objects. The processor can cause the NFT to be redeemed for the physical object, and upon redemption, the processor can destroy the NFT.

Based on the data associated with the user, the processor can determine a prize category among the multiple prize categories to be the activity. For example, the processor can determine the prize category to be the activity based on the amount of time the user spends inside the game or based on the user's age. The activity can include designing an aspect associated with the video game, such as a video game event, a video game tournament, a video game character, a video game background or prop, etc. The processor can receive a designed aspect associated with the video game from the user. The processor can provide the designed aspect associated with the video game to multiple users in the video game. In one embodiment, the multiple users can exchange a second item for an instance of the designed aspect associated with the video game. The processor can provide at least a portion of the exchanged second item to the user.

The processor can obtain the data associated with the user including an amount of time the user spent in the video game, and/or the age of the user. The processor can determine whether the amount of time the user spent in the video game is above a predetermined threshold. For example, the predetermined threshold can be equal to the 90th percentile top times spent in the game. Similarly, the processor can determine whether the user is below a certain age threshold, such as 30 years old. Upon determining that the amount of time the user spent in the video game is above the predetermined threshold, the processor can determine that the prize associated with the user includes the activity. Similarly, if the user's age is below the age threshold, the processor can determine that the prize includes the activity, otherwise the prize can include the item. Upon determining the amount of time the user spent in the video game is below the predetermined threshold, the processor can determine that the prize associated with the user includes the item.

The processor can receive a request from the user device to redeem a virtual item for a physical item. The processor can determine whether a quantity of the virtual items exceeds a predetermined threshold. The predetermined threshold can vary based on the item. For example, for easy-to-obtain items, the predetermined threshold can be over 10, while for harder-to-obtain items, the predetermined threshold can be 1. Upon determining that the number of virtual items exceeds the predetermined threshold, the processor can cause the user to receive the physical item. Upon determining that the number of virtual items does not exceed the predetermined threshold, the processor can provide a notification to the user including the predetermined threshold.

### Computer System

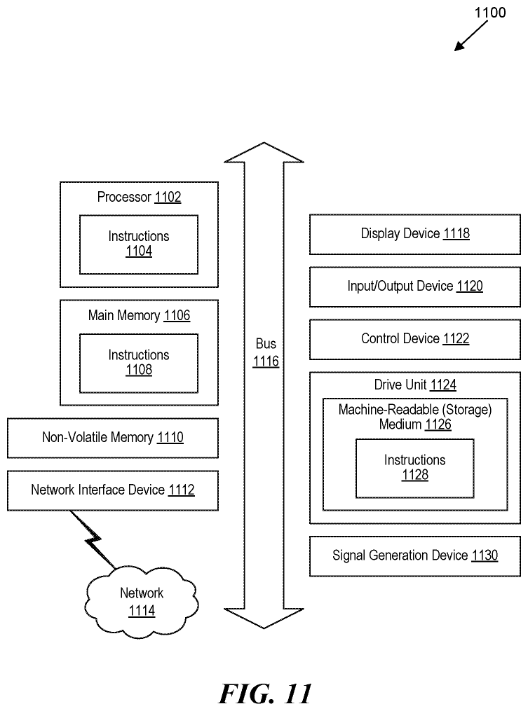

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a video display device 1118, an input/output device 1120, a control device 1122 (e.g., keyboard and pointing device), a drive unit 1124 that includes a storage medium 1126, and a signal generation device 1130, which are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the Figures and any other components described in this specification can be implemented.

The computer system 1100 can take any suitable physical form. For example, the computer system 1100 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 1100. In some implementations, the computer system 1100 can be an embedded computer system, a system-on-chip (SOC), a single-board computer system (SBC), or a distributed system such as a mesh of computer systems, or it can include one or more cloud components in one or more networks. Where appropriate, one or more computer systems 1100 can perform operations in real time, in near real time, or in batch mode.

The network interface device 1112 enables the computer system 1100 to mediate data in a network 1114 with an entity that is external to the computer system 1100 through any communication protocol supported by the computer system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable (storage) medium 1126 can include any medium that is capable of storing, encoding, or carrying a set of instructions for execution by the computer system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1110, removable flash memory, hard disk drives, optical disks, and transmission-type media such as digital and analog communication links.

In general, the routines executed to implement examples herein can be implemented as part of an OS or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computer system 1100 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system to personalize a video game prize, the system comprising:
at least one hardware processor; and
at least one non-transitory memory storing instructions, which, when executed by the at least one hardware processor, cause the system to:
obtain data associated with a player by:
obtaining an indication of a portal through which the player reached a video game,
wherein the portal includes an indication of a software platform through which the player reached the video game; and
obtaining device information associated with a user device;
based on the data associated with the player, determine a geographic location associated with the player;
obtain multiple prize categories including an item and an activity; and
based on the data associated with the player, the geographic location associated with the player, and the multiple prize categories, personalize the video game by creating the video game prize associated with the player in a prize category among the multiple prize categories.

2. The system of claim 1, comprising instructions to:
based on the data associated with the player, determine a prize category among the multiple prize categories to be the activity,
wherein the activity includes designing an aspect associated with the video game;
receive a designed aspect associated with the video game from the player; and
provide the designed aspect associated with the video game to multiple users associated with the video game,
wherein the multiple users can exchange a second item for an instance of the designed aspect associated with the video game; and
provide at least a portion of the exchanged second item to the player.

3. The system of claim 1, comprising instructions to:
obtain the device information associated with the device including an IP address associated with the device;
based on the IP address, determine the geographic location associated with the player;
obtain an indication of a preferred device type associated with the geographic location; and
based on the indication of the preferred device type associated with the geographic location, create the video game prize including the preferred device type.

4. The system of claim 1, wherein the instructions to create the video game prize comprise instructions to:
generate a non-fungible token (NFT) indicating the video game prize, wherein the NFT is configured to be redeemed for a physical object;
cause the NFT to be redeemed for the physical object; and
upon redeeming the NFT, cause the NFT to be destroyed.

5. The system of claim 1, comprising instructions to:
based on the data associated with the player, determine a prize category among the multiple prize categories to be the activity,
wherein the activity includes designing an aspect associated with the video game;
receive a designed aspect associated with the video game from the player; and
provide the designed aspect associated with the video game to multiple users in the video game.

6. The system of claim 1, comprising instructions to:
obtain the data associated with the player including an amount of time the player spent in the video game;
determine whether the amount of time the player spent in the video game is above a predetermined threshold;
upon determining that the amount of time the player spent in the video game is above the predetermined threshold, determine that the video game prize associated with the player includes the activity; and
upon determining the amount of time the player spent in the video game is below the predetermined threshold, determine that the video game prize associated with the player includes the item.

7. The system of claim 1, comprising instructions to:
receive a request from the user device to redeem a virtual item for a physical item;
determine whether a quantity of the virtual item exceeds a predetermined threshold;
upon determining that the quantity of virtual item exceeds the predetermined threshold, cause the player to receive the physical item; and
upon determining that the quantity of virtual item does not exceed the predetermined threshold, provide a notification to the player including the predetermined threshold.

8. A method comprising:
obtaining data associated with a user by:
obtaining an indication of a portal through which the user reached a video game; and
obtaining device information associated with a user device;
obtaining multiple prize categories including an item and an activity; and
based on the data associated with the user and the multiple prize categories, personalizing the video game by creating a video game prize associated with the user in a prize category among the multiple prize categories.

9. The method of claim 8, comprising:
obtaining the device information associated with the device including an IP address associated with the device;
based on the IP address, determining a geographic location associated with the user;
obtaining an indication of a preferred device type associated with the geographic location; and
based on the indication of the preferred device type associated with the geographic location, creating the video game prize including the preferred device type.

10. The method of claim 8, wherein creating the video game prize comprises:
generating an NFT indicating the video game prize,
wherein the NFT is configured to be redeemed for a physical object;
causing the NFT to be redeemed for the physical object; and
upon redeeming the NFT, causing the NFT to be destroyed.

11. The method of claim 8, comprising:
based on the data associated with the user, determining a prize category among the multiple prize categories to be the activity,
wherein the activity includes designing an aspect associated with the video game;
receiving a designed aspect associated with the video game from the user; and
providing the designed aspect associated with the video game to multiple users in the video game.

12. The method of claim 8, comprising:
based on the data associated with the user, determining a prize category among the multiple prize categories to be the activity,
wherein the activity includes designing an aspect associated with the video game;
receiving a designed aspect associated with the video game from the user; and
providing the designed aspect associated with the video game to multiple users associated with the video game,
wherein the multiple users can exchange a second item for an instance of the designed aspect associated with the video game; and
providing at least a portion of the exchanged second item to the user.

13. The method of claim 8, comprising:
obtaining the data associated with the user, including an amount of time the user spent in the video game;
determining whether the amount of time the user spent in the video game is above a predetermined threshold; and
selectively determining that the video game prize associated with the user includes the activity or the item based on determining that the amount of time the user spent in the video game is above the predetermined threshold.

14. The method of claim 8, comprising:
receiving a request from the user device to redeem a virtual item for a physical item;
determining whether a quantity of the virtual item exceeds a predetermined threshold; and
selectively causing the user to receive the physical item or providing a notification to the user including the predetermined threshold, based on determining that the quantity of virtual item exceeds the predetermined threshold.

15. At least one non-transitory, computer-readable storage medium storing instructions, which, when executed by at least one data processor of a system, cause the system to:
obtain data associated with a user by:
obtaining an indication of a portal through which the user reached a video game,
wherein the portal includes an indication of a software platform through which the user reached the video game; and
obtaining device information associated with a user device;
obtain multiple prize categories including an item and an activity; and
based on the data associated with the user and the multiple prize categories, personalize the video game by creating a video game prize associated with the user in a prize category among the multiple prize categories.

16. The at least one non-transitory, computer-readable storage medium of claim 15, comprising instructions to:
obtain the device information associated with the device, including an IP address associated with the device;
based on the IP address, determine a geographic location associated with the user;
obtain an indication of a preferred device type associated with the geographic location; and
based on the indication of the preferred device type associated with the geographic location, create the video game prize including the preferred device type.

17. The at least one non-transitory, computer-readable storage medium of claim 15, wherein the instructions to create the video game prize comprise instructions to:
generate an NFT indicating a video game prize,
wherein the NFT is configured to be redeemed for a physical object;
cause the NFT to be redeemed for the physical object; and
upon redeeming the NFT, cause the NFT to be destroyed.

18. The at least one non-transitory, computer-readable storage medium of claim 15, comprising instructions to:
based on the data associated with the user, determine a prize category among the multiple prize categories to be the activity,
wherein the activity includes designing an aspect associated with the video game;
receive a designed aspect associated with the video game from the user; and
provide the designed aspect associated with the video game to multiple users in the video game.

19. The at least one non-transitory, computer-readable storage medium of claim 15, comprising instructions to:
based on the data associated with the user, determine a prize category among the multiple prize categories to be the activity,
wherein the activity includes designing an aspect associated with the video game;
receive a designed aspect associated with the video game from the user; and
provide the designed aspect associated with the video game to multiple users associated with the video game,
wherein the multiple users can exchange a second item for an instance of the designed aspect associated with the video game; and
provide at least a portion of the exchanged second item to the user.

20. The at least one non-transitory, computer-readable storage medium of claim 15, comprising instructions to:
obtain the data associated with the user, including an amount of time the user spent in the video game;
determine whether the amount of time the user spent in the video game is above a predetermined threshold;
upon determining that the amount of time the user spent in the video game is above the predetermined threshold, determine that the video game prize associated with the user includes the activity; and
upon determining the amount of time the user spent in the video game is below the predetermined threshold, determine that the video game prize associated with the user includes the item.

21. The at least one non-transitory, computer-readable storage medium of claim 15, comprising instructions to:
receive a request from the user device to redeem a virtual item for a physical item;
determine whether a quantity of the virtual item exceeds a predetermined threshold;
upon determining that the quantity of the virtual item exceeds the predetermined threshold, cause the user to receive the physical item; and
upon determining that the quantity of the virtual item does not exceed the predetermined threshold, provide a notification to the user including the predetermined threshold.

22. A system comprising:
at least one hardware processor; and
at least one non-transitory memory storing instructions, which, when executed by the at least one hardware processor, cause the system to:
provide data associated with a player by:
obtaining an indication of a portal through which the player reached a video game,
wherein the portal includes an indication of a software platform through which the player reached the video game;
based on the data associated with the player, cause a determination of a geographic location associated with the player; and
based on the data associated with the player and the geographic location associated with the player, cause a personalization of the video game by causing a creation of a video game prize suitable to the player.
